(19) United States
(12) Patent Application Publication
(10) Pub. No.: US 2005/0251477 A1
(43) Pub. Date: Nov. 10, 2005

(54) On-line billing system and method of the same

(75) Inventors: Chia-Youn Chang, Tao-Youn County (TW); Li-Hua Lin, Ba-Dei City (TW); Tien-Chieh Wu, Taipei City (TW); Hsiao-Huei Chao, Kaoshiung City (TW); Le-Yun Chen, Hsin-Chu City (TW); Hung-Yi Yang, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: MITAC INTERNATIONAL CORP.

(21) Appl. No.: 10/840,226

(22) Filed: May 7, 2004

(51) Int. Cl. G06F 17/60

(52) U.S. Cl. 705/40

(57) ABSTRACT

An on-line billing system and method capable of integrating the electronic billing and payment process, comprises the steps of: forwarding the file of check sheet details to HUBWEB interface, generating the file of check sheet, issuing statement of account, inquiring/deleting/printing the corresponding statement of account/inquiry invoice, restoring statement of account back to ERP, restoring confirmed dispute of check sheet by batch to HUBWEB interface, generating the file of statement of account details and generating the invoice file. By consolidating the details of check sheet from ERP and forwarding to HUBWEB, the system further activates HUBWEB to generate a file of check sheet for the procedure as inquire check sheet, mark dispute of check sheet, confirm dispute of check sheet and delete dispute of check sheet. Meanwhile, in the process to mark, confirm and delete dispute of check sheet, the system will initiate the electrical mails to notify the relevant personnel.

### BACKGROUND OF THE INVENTION

1. Field of the Invention

The present invention relates to a method for the suppliers in the supply chain to integrate the electronic billing and payment process, in particular to the on-line billing process applied by suppliers.

2. Background Description

Traditionally, the business transaction procedure is the sales representative or the procurement team places the orders to the suppliers for raw materials, parts or finished goods. Ordering might be upon the sales forecast or the volume summed up from the purchase orders. Thus, the suppliers receive the orders then check the stock. If the stock and the production can't satisfy the demand, the suppliers have to further deal with the upstream suppliers. This demand-supply relationship is called Supply Chain. Now there are some applications such as ORACLE or AGILE for the supply chain management of purchasing, shipment, parts and materials and it's called ERP (Enterprise Resource Planning).

What ERP covers is flexible; it can be wide as including human resource, sales, risk analysis, finance, performance evaluation and so on or narrow as only IQC (Incoming Quality Control). However, in between the application of supply chain and the control of internal approval process, what ERP can do is not real-time and automatic enough to meet the on-line billing because it requires excessive manual work to watch for the timing of billing and payment or to control the receipt of goods and the release of payment. Especially when the profit is so tied and the market price drops so fast, to well control the payment can definitely avoid the unnecessary cash outflow and the loss of interest. Moreover, it's going to be an ultimate support to build up the business advantage if the on-line billing system and the accurate real-time payment process can displace the excessive manual work.

The traditional electronic billing process is typically as the supplier delivers goods. The inventory keeper and the component quality control inspecting goods, then rejection applied if the quality check is failed, or stock-in if quality passed. The keeper will submit the supplier the receiving ticket or the related paper for billing and notify the financial department. After the reception of the receiving ticket, the supplier starts the billing process, such as generating check sheet, printing through Web browsers, checking the purchasing allowance, issuing uniform invoice for tax filing, and then processing payment.

Referring FIG. 1, which shows the best developed electronic billing system by the inventors, the concept of this aforementioned operation can be more apparent. First, the center plant (headquarter or subsidiary plant) place the purchase orders or forecast to the suppliers. The suppliers deliver goods to the center plant. Then the center plant stocks in the goods and then submits the receiving ticket. Upon each shipment, the check sheet is consolidated and generated. Meanwhile, purchasing allowance is processed at Web interface. If ERP is capable of covering this procedure, all the information is submitted to the related directors for approval in ERP. Following the approval, the uniform invoice is issued for on-line tax filing. Finally, the banking institution releases the payment to the suppliers on the settled due date.

As FIG. 1, such process incorporates some ERP techniques. However, the major drawback contains excessive manual works. For instance, when the check sheet is duplicated and the content is not matched with what on the origin. It must be particularly taken care to confirm price and quantity, and it requires manpower to communicate over phone or by meetings. Besides, if the payment is different from the amount the statement of account, it requires the manual work to review all the associated documents because the discrepancy may be caused by the different timing of shipping and billing. No matter what the reason and final results are, the due payment has been delayed and the insufficient amount can't be possibly detected at the moment when the check sheet is presented. In case it's involved with import-export issues and results in the various exchange rates, more complicated communication to clear up the issues will cause the further delay, lots manual works, numerous communication and conferences, and the greater loss. Therefore, to develop a real-time on-line billing system is able to overcome the above drawbacks.

### SUMMARY OF THE INVENTION

It is therefore an object of the present invention to provide suppliers a real-time on-line method which integrates the electronic billing and payment process, containing the advantages as solving the accounts mistakes, avoiding the transaction disputes, offering the paperless environment, the real-time data and the extreme transparency of information.

To approach the above objects, the procedure of the present invention is briefly as follows. The supplier deliver goods, the inventory keeper and quality control inspect the quality and stock in the goods, the check sheet is issued at WEB and proceed to inquire. If the check sheet is errorless, then confirm the check sheet and issue the statement of account and the invoice. If the check sheet is errorless, then generate emails to notify the buyers and key-in the related data onto the statement of account. Thus, the supplier's billing information and the data in ERP of the center plant can be crosschecked and suffice the advantage of the present invention.

Accordingly, the supplier's on-line billing system consists of the following modules: forward the file of check sheet details to HUBWEB interface; generate the file of check sheet at HUBWEB for the procedure as inquire check sheet, mark dispute of check sheet, confirm dispute of check sheet and delete dispute of check sheet; issue statement of account; inquire, delete, print the corresponding statement of account and inquire invoice; restore statement of account back to ERP; restore confirmed dispute of check sheet by batch to HUBWEB interface; generate the file of the statement of account details; generate the invoice file.

It is another object of the present invention to provide the module to generate the file of check sheet, wherein the system will automatically notify the relevant personnel via emails during the process to mark, confirm and delete dispute of check sheet.

According to the yet aspect of the present invention, there is the module to inquire, delete, print statement of account and the inquire invoice, which consists of the inquiry operation about statement of account, payment, return goods allowance and invoice file.

According to yet another aspect of the present invention, there is the module to restore confirmed dispute of check sheet by batch to HUBWEB interface, which is to consolidate the confirmed dispute of check sheet into the check sheet file at HUBWEB to ensure its accuracy.

Accordingly, all the data in ERP and HUBWEB is kept the most updated and real-time accurate when the data is being updated and deleted.

In order to approach the above objects, the present invention yet provides suppliers a solution of on-line billing, which includes the steps of: login step: to sing in the on-line billing system; examine step: to check the authority of users; verify check sheet step: to make sure the accuracy of the check sheet; invoice step: issue the invoice; and print the statement of account step.

Accordingly, there is an examine step to assure the login user is authorized to sign in the on-line billing system. A login user who is not authorized is allowed to immediately apply a user account; however, the user must go through the application process to be authorized; There is another step to mark the dispute of check sheet when the data on check sheet has been rejected in verify check sheet step.

According to the above objects, there is another dispatch email step to notify the relevant personnel of the follow-up notes on dispute of check sheet in mark dispute of check sheet. The data need to be verified can be currency. Furthermore, the data need to be verified is the total amount or the goods quantity.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is the flowchart of a best developed electronic billing system by the inventors;

FIGS. 2A, 2B and 2C shows separated flowcharts of ERP system and HUBWEB data flow of the present invention;

FIG. 3 is the flowchart of on-line billing process of the present invention;

FIG. 4 is the flowchart to process the dispute of check sheet in the on-line billing system of the present invention;

FIG. 5 is the screen shot of the page to login HUBWEB of the present invention;

FIG. 6 is the screen shot of clicking inquire check sheet;

FIG. 7 is the screen shot of inquiring check sheet and its outcome;

FIG. 8 is the details of inquiry outcome of check sheet;

FIG. 9 is the screen shot of marking dispute of check sheet in step 320;

FIG. 10 is the screen shot of confirming dispute of check sheet;

FIG. 11 is the record of dispute of check sheet notifying and automatic email notifying;

FIG. 12 is the screen shot of issuing statement of account in step 321;

FIG. 13 is the screen shot of issuing statement of account;

FIG. 14 is the screen shot of payment status/delete/print;

FIG. 15 is the screen shot of request to print statement of account in step 324;

FIG. 16 is the screen shot of function of invoice issue/complete/delete;

FIG. 17 is the screen shot for keying in term and condition of invoice issue/complete/delete follwing the previous selection;

FIG. 18 is the report of inquiry of the statement of account and payment record status in step 325; and

FIG. 19 is the print of the invoice details.

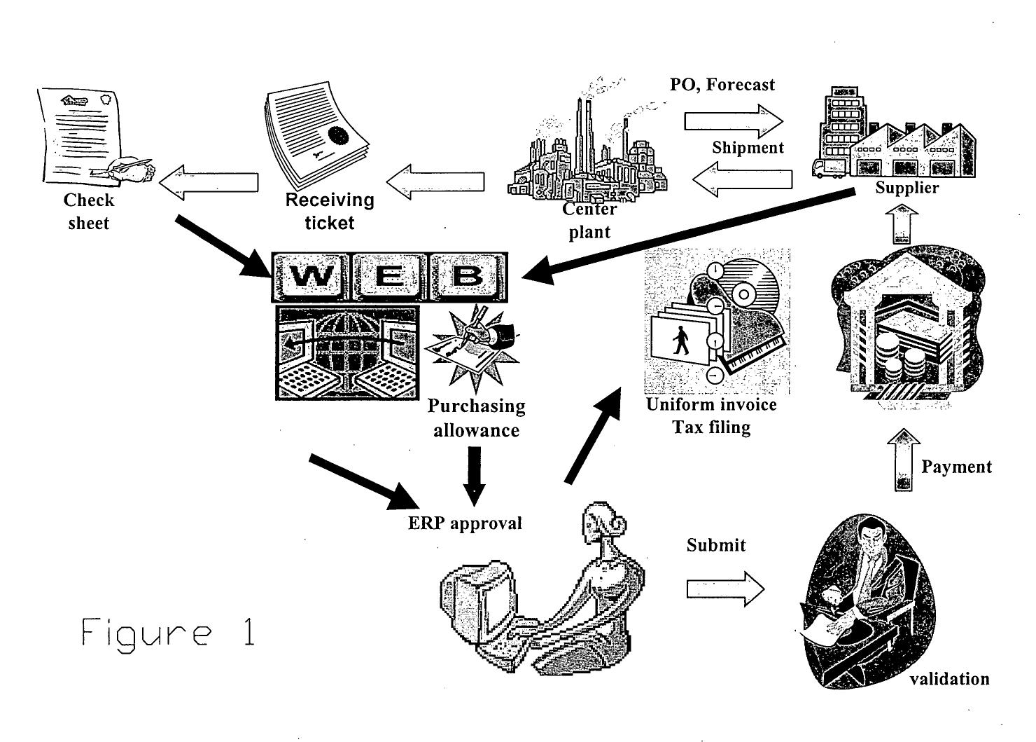

### DETAILED DESCRIPTION OF A PREFERRED EMBODIMENT OF THE INVENTION

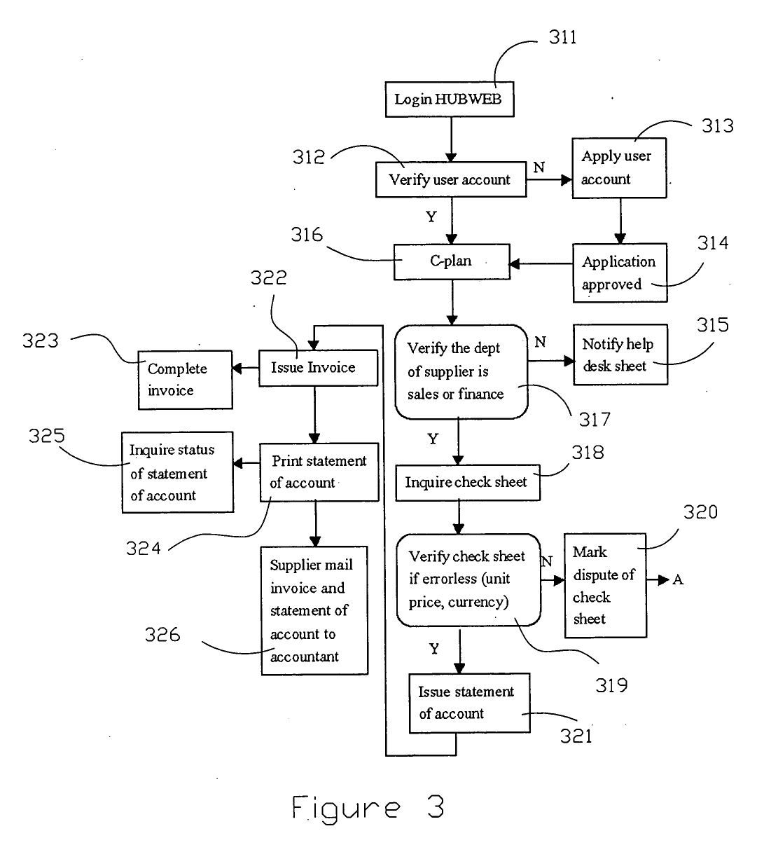

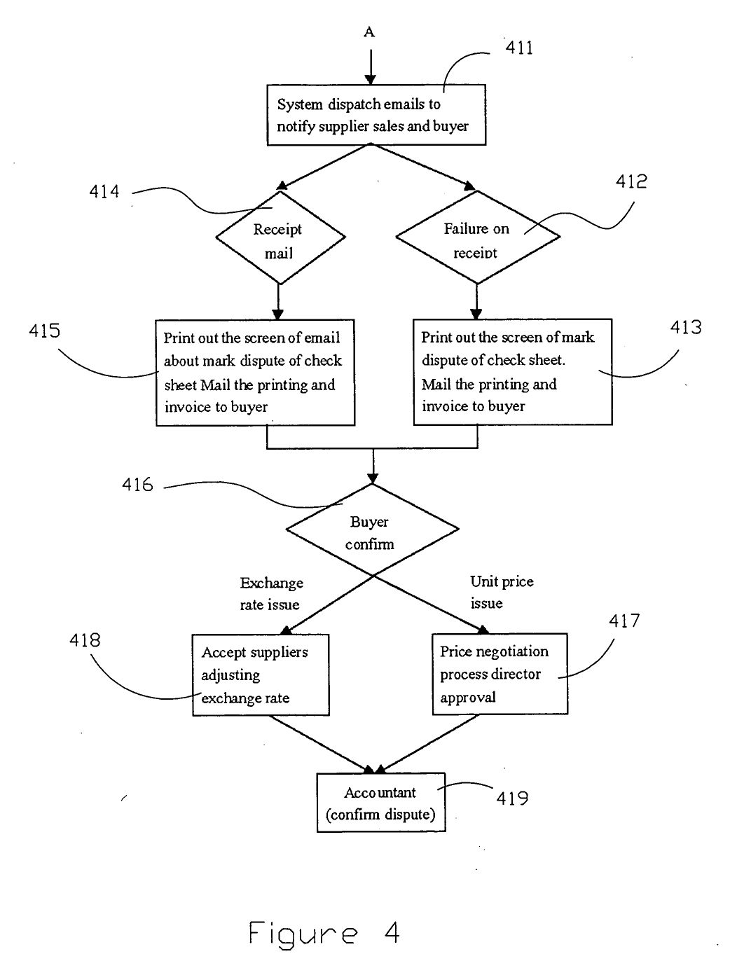

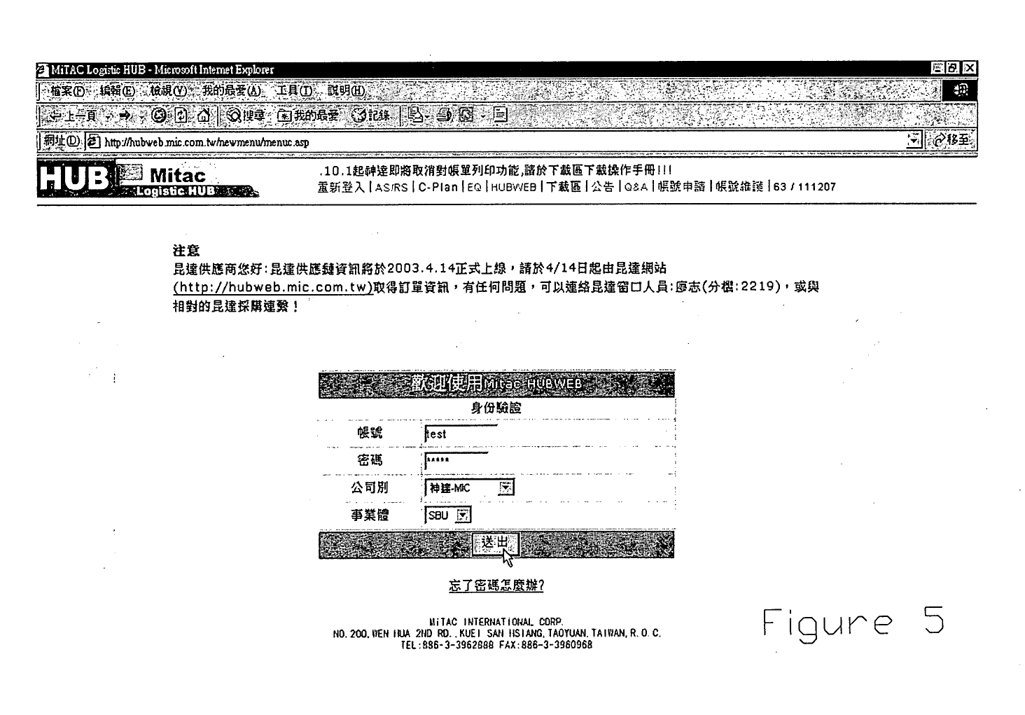

Please refer to FIG. 3, which shows the function block diagram of the present invention. FIG. 3 demonstrates the electrical system with the driving module.

The procedure of the present invention is briefly as followings. Firstly, the supplier delivers goods. The inventory keeper and quality control team will inspect the quality of goods. Once goods are accepted, at Web the check sheet is therefore issued and proceeded with the inquiry. If the check sheet is errorless, then confirm the check sheet and issue the statement of account and issue the invoice. If the check sheet is errorless, the system dispatches electrical mails (emails) to notify the buyers and the related data will be processed onto the statement of account.

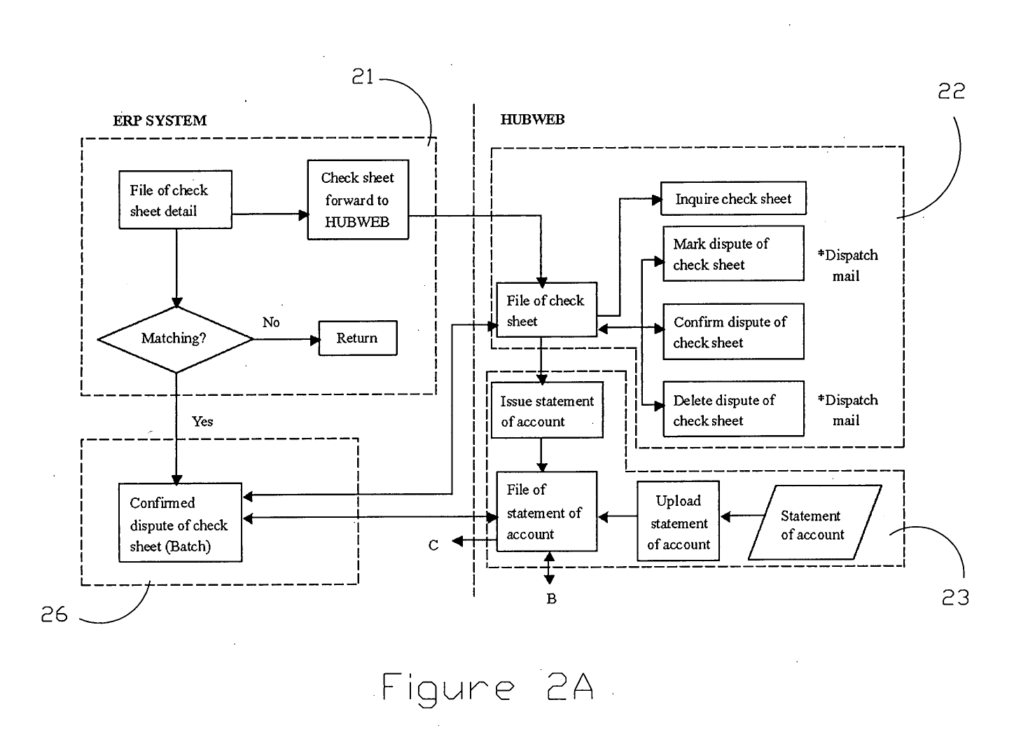

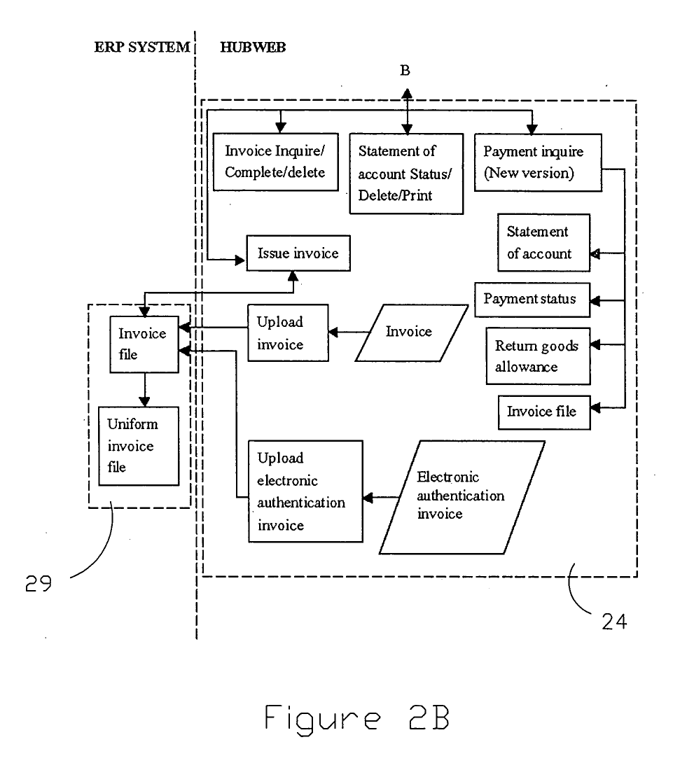

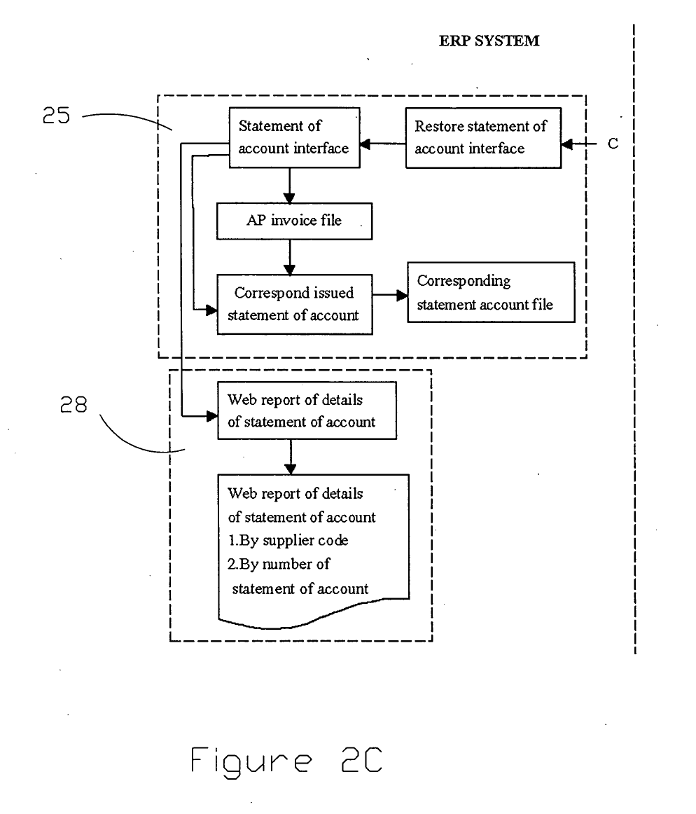

Please refer to FIGS. 2A, 2B and 2C, which are continuous flowcharts of the present invention. At first in the Block 21, the ERP system forwards the file of check details to HUBWEB. In Block 22, the check file is generated at HUBWEB for the procedure as inquiring check sheet and marking, confirming and deleting dispute of check sheet. Meanwhile, in the process to mark, confirm and delete dispute of check sheet, the system will dispatch emails to notify the relevant personnel. Once the check sheet at HUBWEB has been confirmed errorless, the process will move to Block 23, wherein the file of statement of account is generated and also issue the statement of account. Afterwards, Block 24 is to inquire, delete, print statement of account and inquire invoice. When activating the function to issue the invoice, the process is forward to Block 29, wherein the system will generate the invoice file and the uniform invoice file as well for on-line tax filing. In Block 23, the statement of account, besides being able to be inquired and printed in Block 24, will be restored back to ERP and start the corresponding procedure and store the record. In addition, in Block 22, if the check sheet is marked with dispute, it will be sent back to ERP and generate the batch file of dispute of check sheet. As Block 26, this batch file of dispute of check sheet is also going to be restored to HUBWEB as shown in Block 23, wherein the dispute information will be consolidated into the file of statement of account. In Block 25, the file of statement of account from HUBWEB is further forward to Block 28, wherein the file of statement of account is generated, which is also for usage of searching; the index can be the supplier code or the number of check sheet.

FIGS. 2A, 2B and 2C present the data flow between ERP and HUBWEB and the following FIGS. 3 and 4 illustrate the flow how the supplier manipulate HUBWEB. At first, the supplier has to login HUBWEB (Step 311); next the user account is confirmed in Step 312; if the user account is invalid then go to Step 313 where to apply the user account; if the user account is valid or the application of user account is completed in Step 314, then go to the main screen of login HUBWEB (Step 316, the exemplary implementation of the present invention is C-Plan and E-Billing system at Mitac International Corp.); next in Step 317, verify if the login user is in the associated supplier's sales or financial departments, if not then go to Step 315 to notify help desk, if yes then go to Step 318, where to offer the function to inquire check sheet and verify the related details as well, the practice of the present invention is to confirm the currency as shown in Step 319, it also can be the confirmed date of check sheet or the date of purchase; if the currency is detected error, go to Step 320 where to mark the dispute of check sheet then go to Block diagram A which will be illustrated in FIG. 4; if the currency is correct, go to Step 321 where to proceed the procedure to issue the statement of account; afterwards, the invoice is issued in Step 322 or go to Step 323 where to complete the procedure to issue the invoice; subsequently in Step 324 the invoice is printed as one of the billing documents; at the same time, the file of statement of account is generated in Block 28 of FIG. 2C for purpose to inquire statement of account (Step 325); the statement of account and the invoice send to the supplier's financial dept (Step 326).

In regard to mark dispute of check sheet (as A in FIG. 3), when check sheet is marked with disputes in Step 411, wherein HUBWEB will initiate emails to the relevant personnel of supplier; in Step 412, when the emails is failed on delivery or no response from addressee, the email about the dispute of check sheet will be printed out and be sent to the center plant's procurement team; following the printout is successfully sent to the center plant's procurement team, the procurement team should confirm the receipt and follow up the issues such as unit price error, inaccurate quantity or wrong currency exchange rate; furthermore, based on the data file, related report or documents created, the dispute is cleared up (Step 417, 418 and 419).

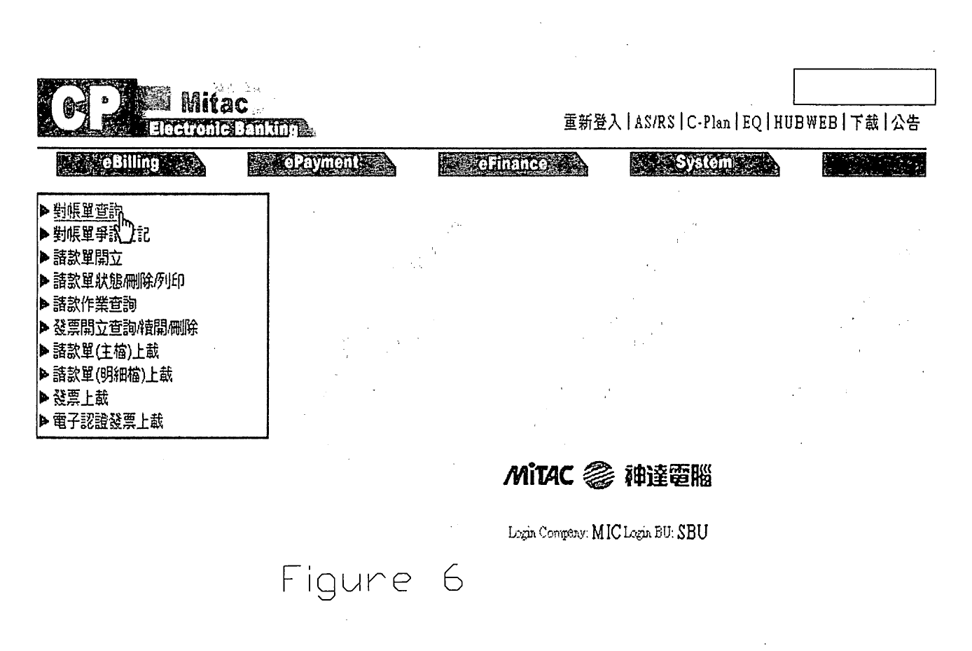

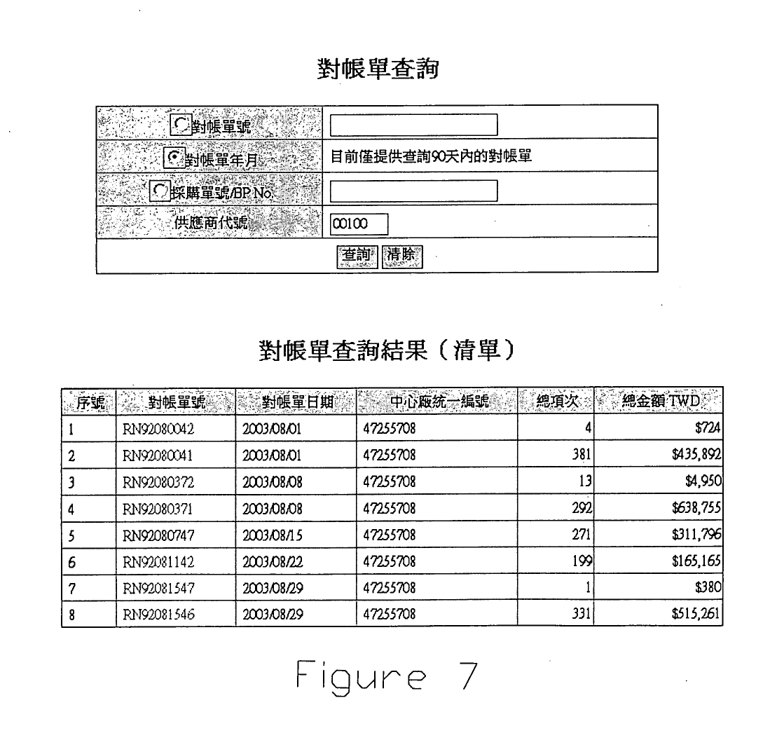

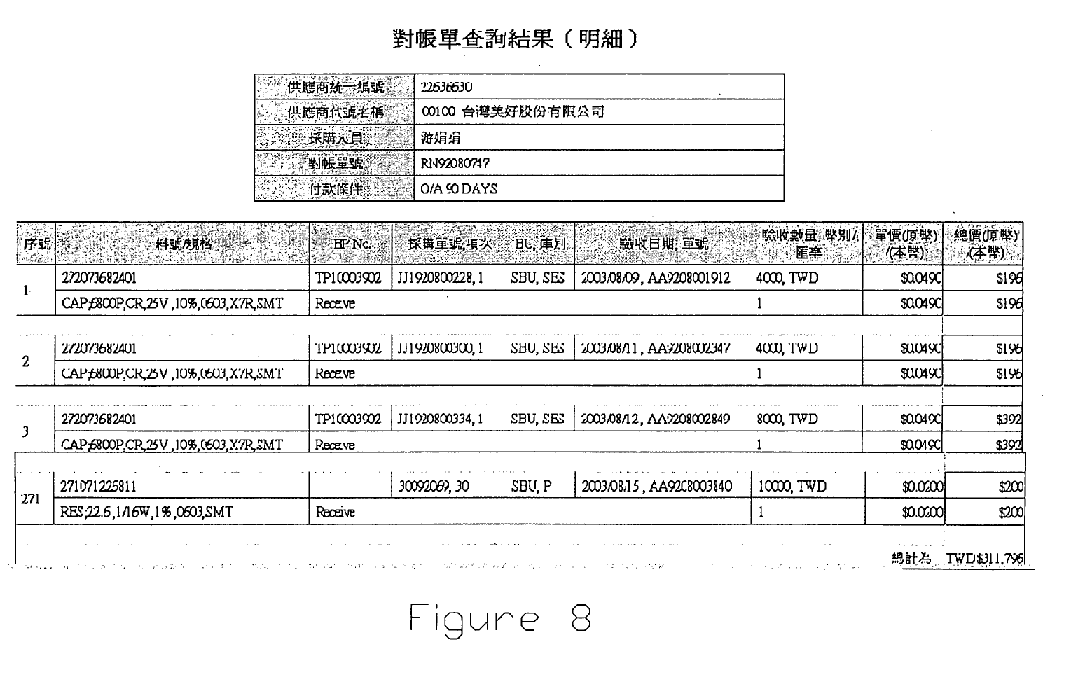

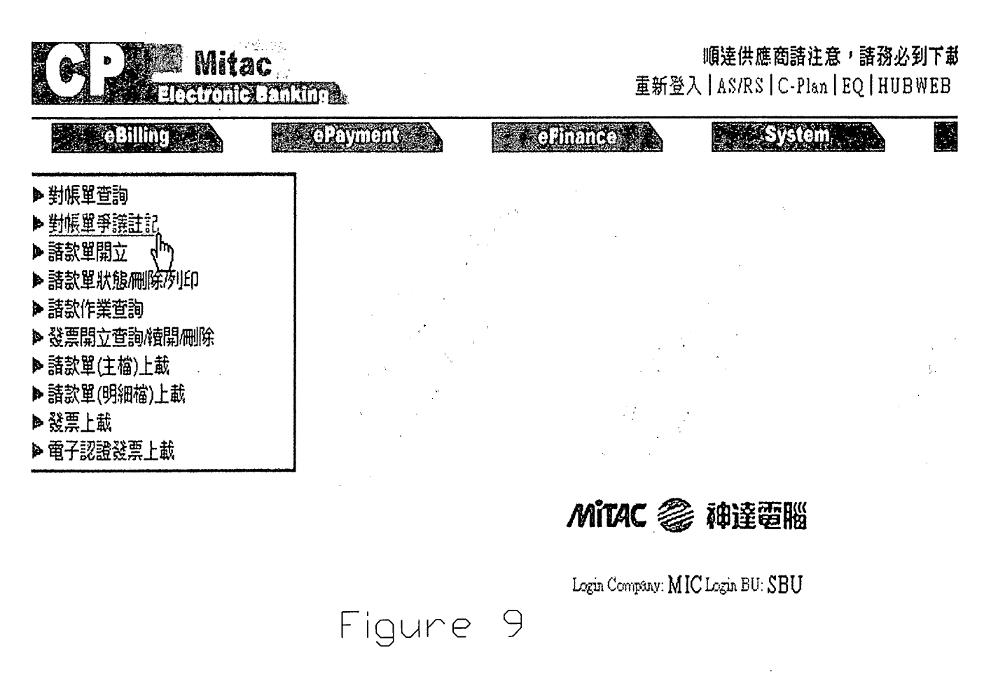

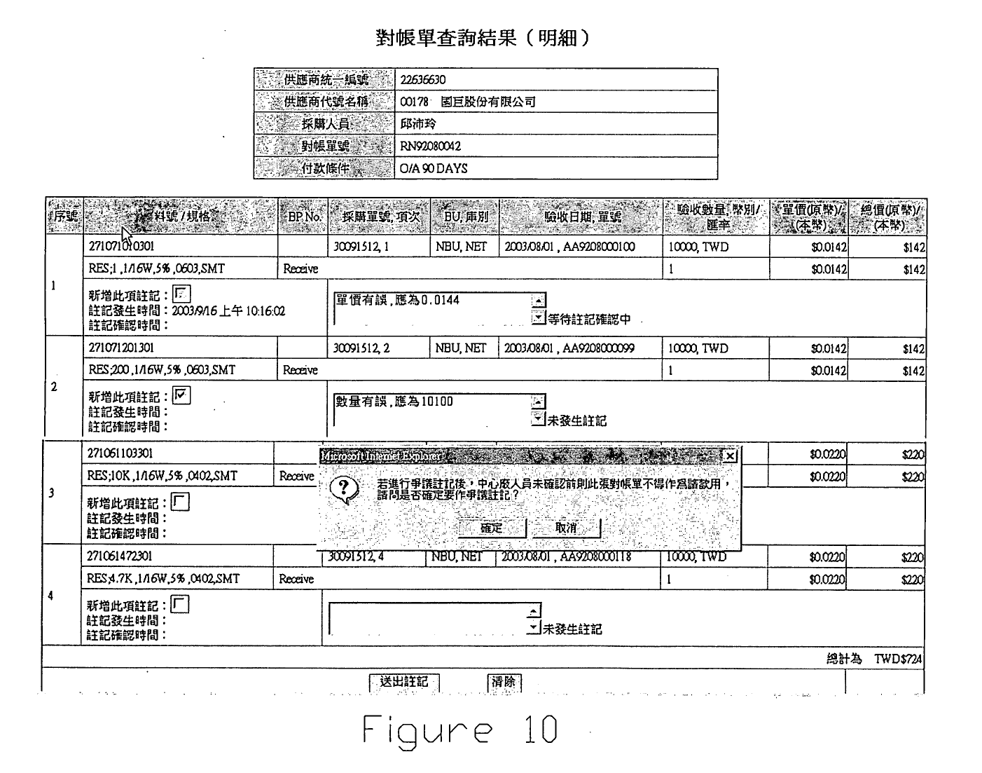

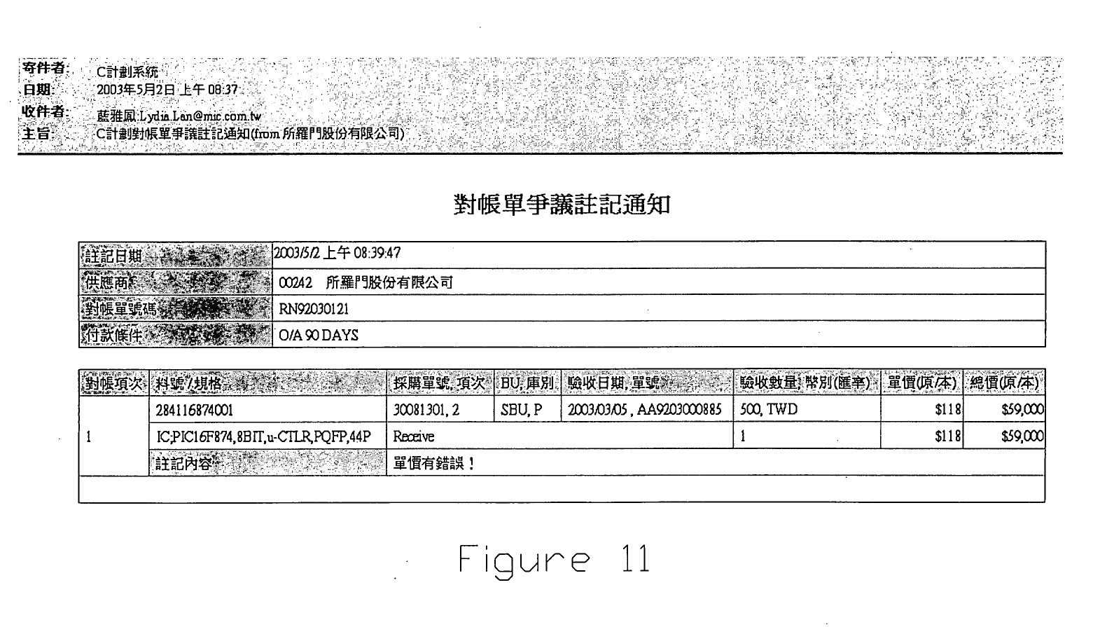

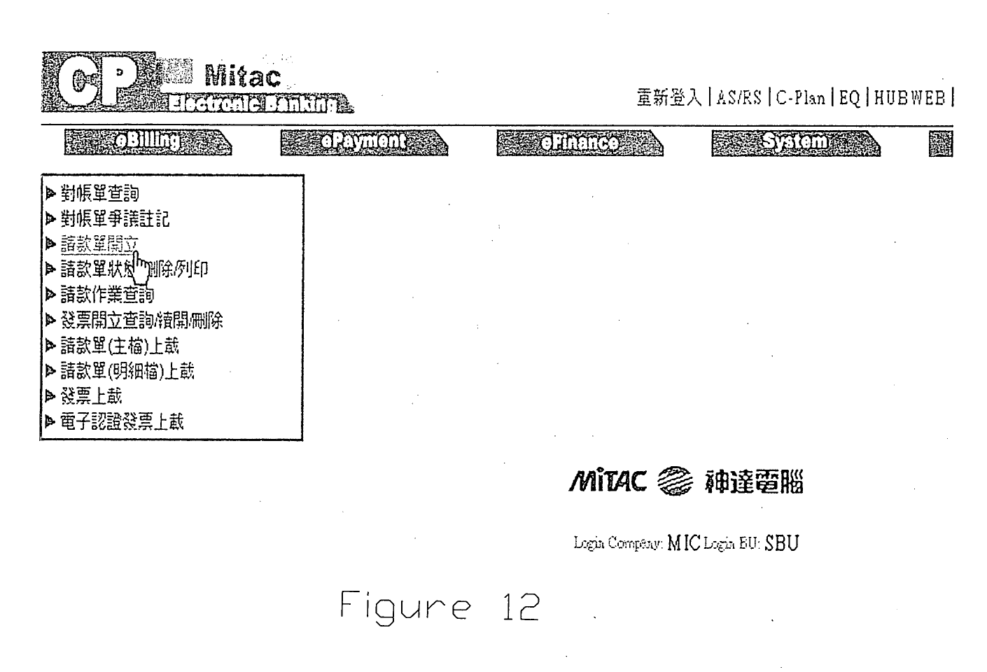

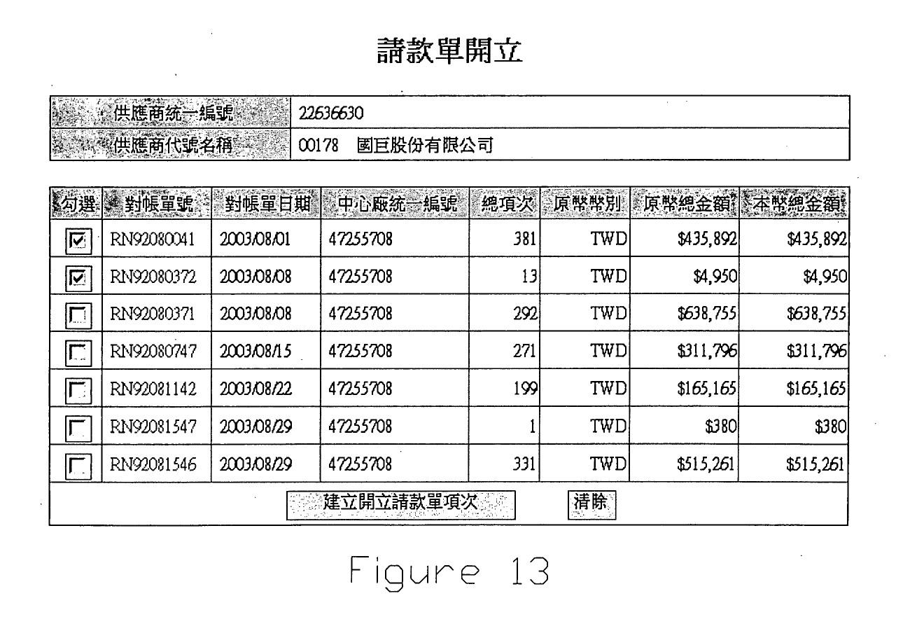

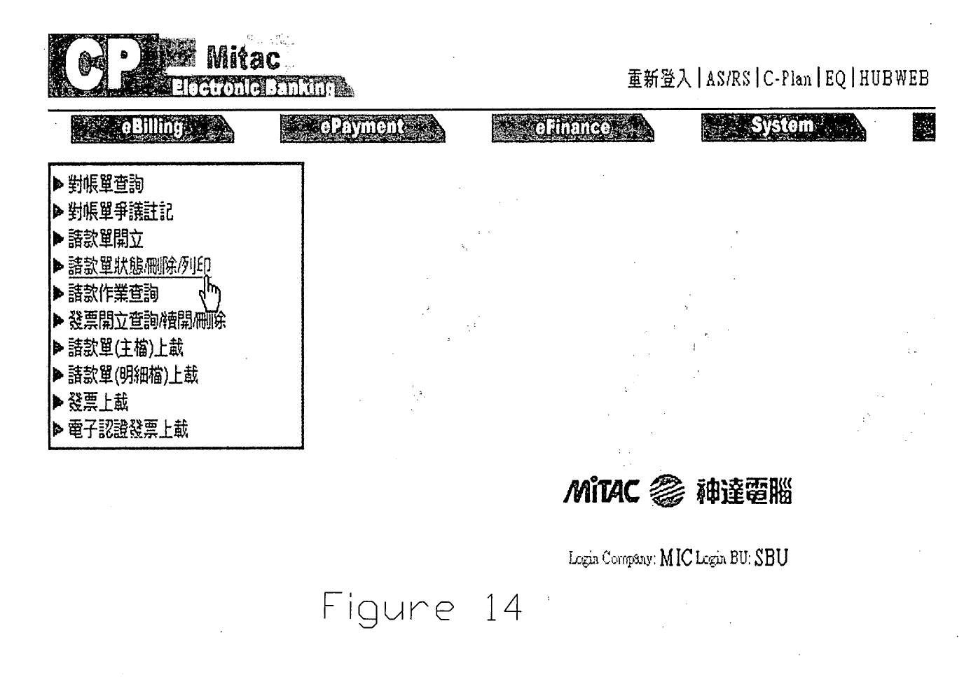

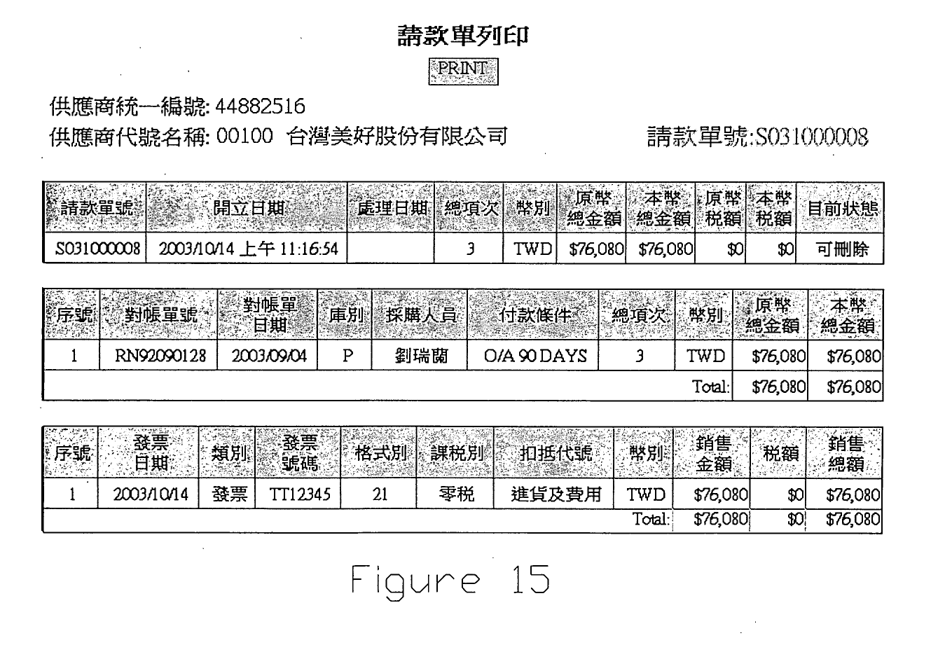

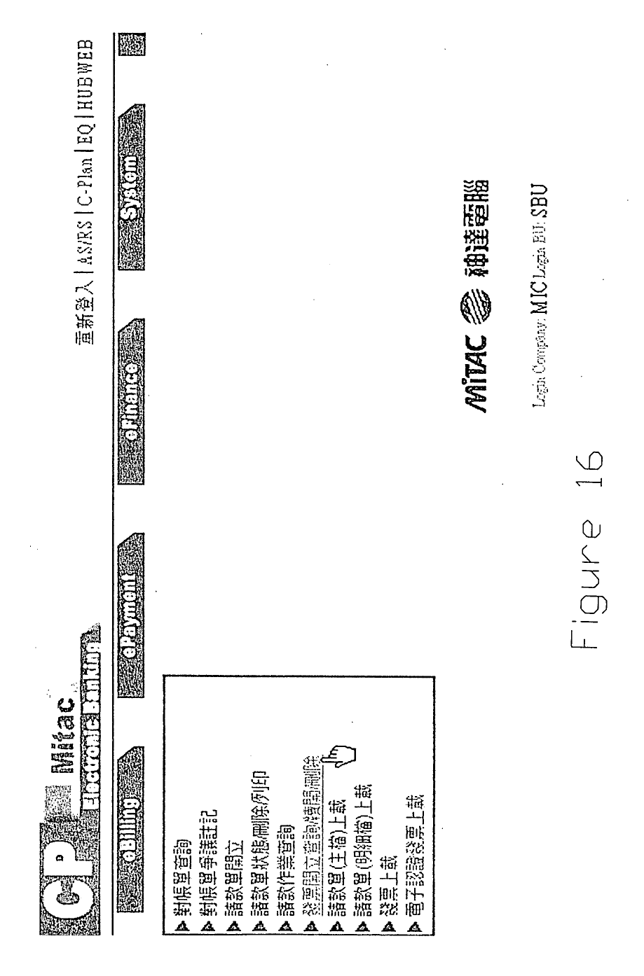

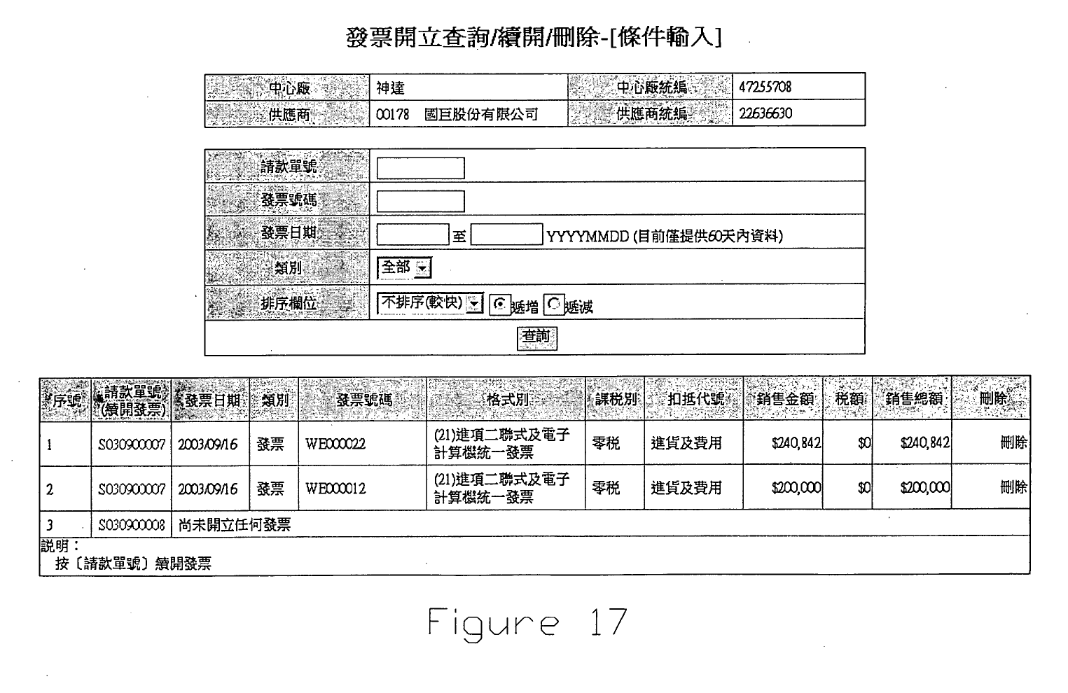

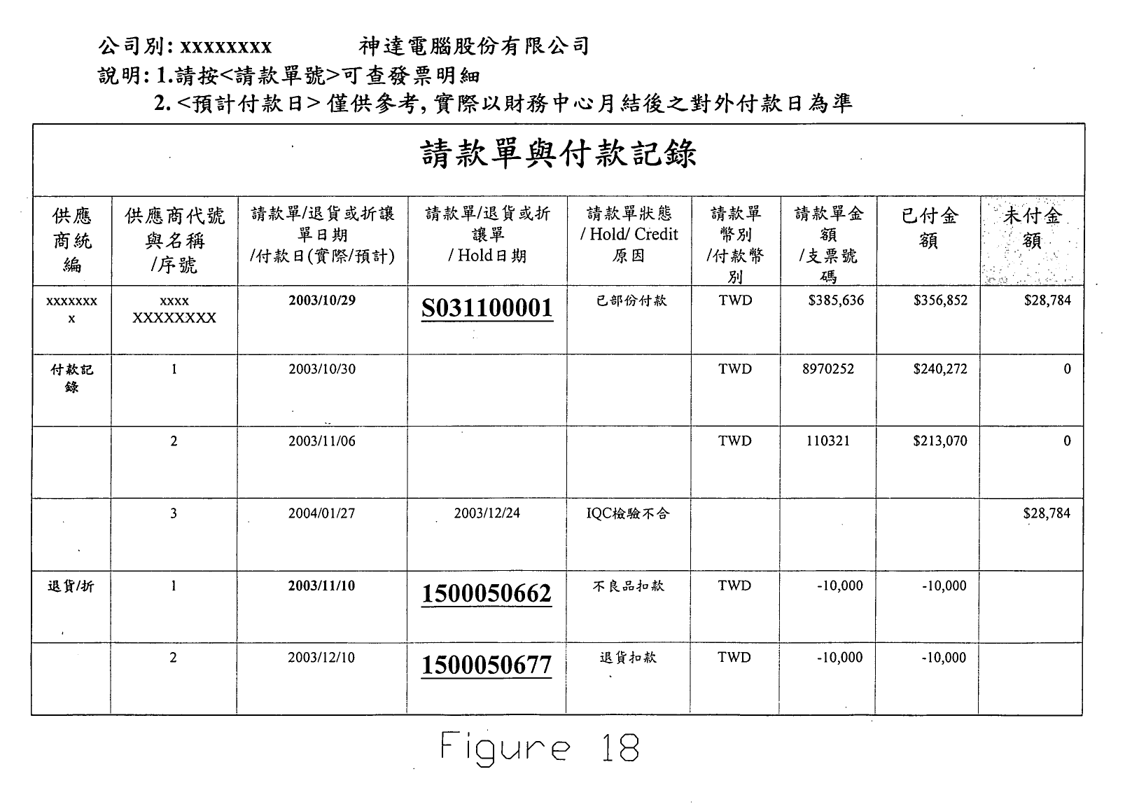

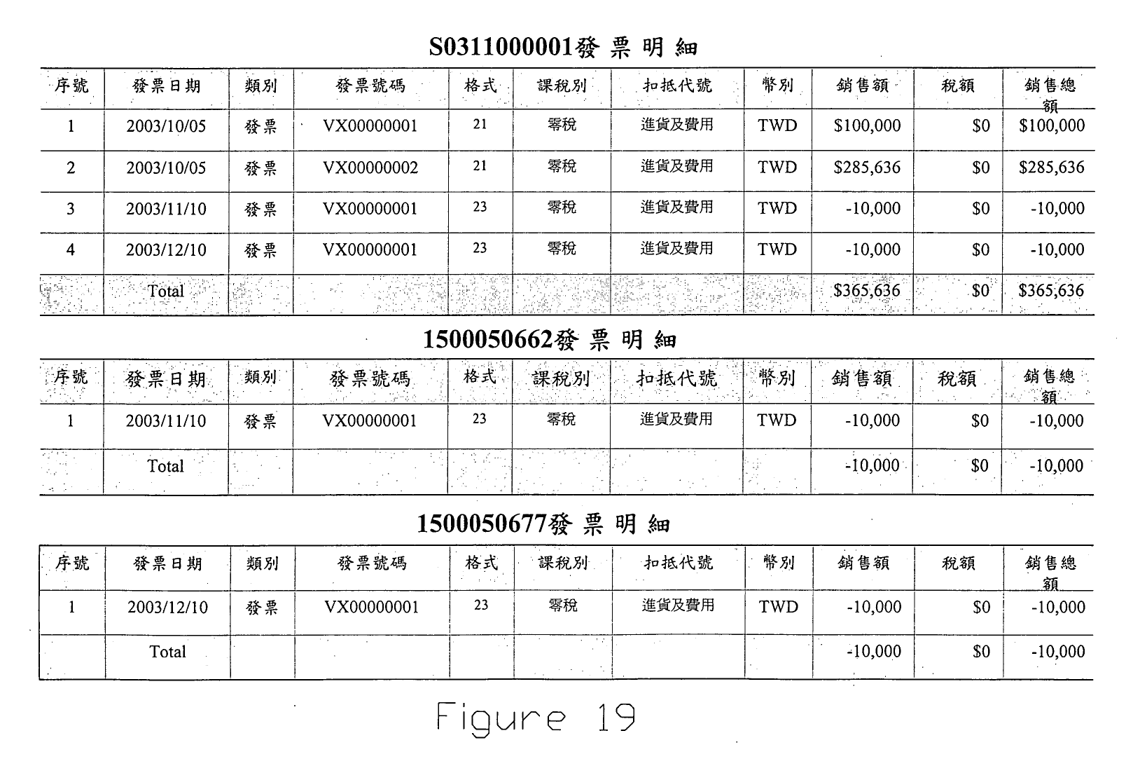

FIG. 5 is the superior exemplary implementation of the present invention as the screen of login HUBWEB in Step 311 in FIG. 3. FIG. 6 is the screen to click inquire check sheet in Step 318 in FIG. 3. FIG. 7 is the screen to inquire check sheet and its outcome. FIG. 8 is the details of inquiry outcome of check sheet. FIG. 9 is the screen to click mark dispute of check sheet in step 320 in FIG. 3. FIG. 10 is the screen to confirm dispute of check sheet (same as Block 26 in FIG. 2A). FIG. 11 is the record of dispute of check sheet notifying and automatic email notifying (Step 412, 413). FIG. 12 is the screen to click issue statement of account in step 321 in FIG. 3. FIG. 13 is the screen to issue statement of account. FIG. 14 is the screen of payment status/delete/print (same as Block 24 in FIG. 2B). FIG. 15 is the screen to print statement of account in step 324. FIG. 16 is the screen to click invoice issue/complete/delete. FIG. 17 is the screen to key in term and condition of invoice issue/complete/delete follwing the previous selection. FIG. 18 is the report of inquiry of the statement of account and payment record status in step 325. FIG. 19 is the screen to print the invoice details. Accordingly, viewing FIG. 5 to FIG. 9 is able to further comprehend the system function and the flow of the present invention.

Therefore, the advantages of the present invention is addressed as: the supplier examine the billing status in advance, the statement of account and the invoice can be immediately issued if errorless, so it can avoid the careless mistakes; moreover, knowing the billing process is on the base of the printing of statement of account, when the supply is complex like numerous items and high volume, it results in the considerable billing documents, whose examination is abysmally manpower-consuming and printout waste of paper and consumptive printing materials; due to the different timing of buyer's releasing the purchase order and the receipt of supplier, the exchange rate causes the problem and the supplier can't successfully complete the billing process, the on-line billing system of the present invention is able to mitigate the disputes for both sides; additionally, when the supplier key in the information of statement of account, the system generates the batch file and transfer the data at HUBWEB to ERP, it can reduce the loading of account personnel; no matter the management of dispute marking or tracking the payment, the present invention can go through and combine with the process of quality control to make the payment information comprehensive.

In general, the procedure of the present invention is briefly as follows. The supplier deliver goods, the inventory keeper and quality control inspect the quality and stock in the goods, the check sheet is issued at WEB and proceed to inquire. If the check sheet is errorless, then confirm the check sheet and issue the statement of account and the invoice. If the check sheet is errorless, then generate emails to notify the buyers and key-in the related data onto the statement of account. Thus, the supplier's billing information and the data in ERP of the center plant can be crosschecked and suffice the advantage of the present invention.

Although preferred embodiments of the present invention have been described in the forgoing description and illustrated in the accompanying drawings, it will be understood that the invention is not limited to the embodiments disclosed, but is capable of numerous rearrangements, modifications, and substituting of parts and elements without departing. from the spirit and scope of the invention. Accordingly, the present invention is intended to encompass such rearrangements, modifications, and substitutions of parts and elements as fall within the scope of the appended claims.

1. An on-line billing system for suppliers comprising:
means for forwarding a detail file of a check sheet to a web-based interface;
means for generating a check sheet file shown at said web-based interface to inquire, mark, confirm and delete dispute of said check sheet;
means for issuing a statement of account;
means for inquiring, deleting, printing said statement of account and for inquiring an invoice;
means for restoring said statement of account back to an ERP system;
means for restoring said dispute of said check sheet by batch to said web-based interface;
means for generating a detailing file of said statement of account; and
means for generating an invoice file.

2. The on-line billing system of claim 1, wherein said means for generating said check sheet file comprises means for notifying relevant personnel via electrical mail communication.

3. The on-line billing system of claim 1, wherein said means for inquiring, deleting, printing said statement of account and for inquiring said invoice comprises means for operating said statement of account, payment, return goods allowance and said invoice file.

4. The on-line billing system of claim 1, wherein said means for restoring said dispute of said check sheet comprises means for consolidating said dispute of said check sheet into said check sheet file at said web-based interface in order to ensure its accuracy.

5. The on-line billing system of claim 1, wherein all data in said ERP system and said web-based interface is kept the most updated and real-time accurate when said data is being updated and deleted.

6. An on-line billing method comprising the steps of:
connecting to a web-based interface for signing in an ERP billing system by a user;
examining authority of said user;
verifying a check sheet for making sure the accuracy of said check sheet being appropriate;
issuing a statement of account;
generating invoice; and
printing said cheek sheet via said web-based interface.

7. The on-line billing system of claim 6, wherein the step of examining is to assure said user is authorized to sign in said billing system.

8. The on-line billing system of claim 6, further comprising a step of applying a supplier account through said web-based interface, if said user is not authorized or allowed to sign in said billing system.

9. The on-billing system of claim 6, wherein a dispute mark is generated when data on said check sheet has been rejected if the result of the step of verifying said check sheet fails.

10. The on-line billing system of claim 9, wherein if said dispute mark is generated, an electrical mail is dispatched to notify relevant personnel.

11. The on-line billing system of claim 9, wherein said data is related to currency of payment.

12. The on-line billing system of claim 9, wherein said data is related to total amount of goods.

13. The on-line billing system of claim 9, wherein said data is related to quantity of goods.
